(19) United States
(12) Patent Application Publication
(10) Pub. No.: US 2011/0314398 A1
(43) Pub. Date: Dec. 22, 2011

(54) INFORMATION TERMINAL, COMPUTER PROGRAM PRODUCT AND METHOD THEREOF

(75) Inventor: Keijiro YANO, Tachikawa-shi (JP)

(73) Assignee: KABUSHIKI KAISHA TOSHIBA, Tokyo (JP)

(21) Appl. No.: 13/036,906

(22) Filed: Feb. 28, 2011

(30) Foreign Application Priority Data
Jun. 16, 2010 (JP) 2010-137102

(51) Int. Cl. G06F 3/048

(52) U.S. Cl. 715/764

(57) ABSTRACT

According to one embodiment, an information terminal is provided with a launcher graphical user interface (GUI), and includes a detector, a determination module, and a display module. The detector detects a change in the state of an application. The determination module determines whether the application is set in the launcher GUI. The display module displays, when the launcher GUI is not displayed and the determination module determines that the application is set in the launcher GUI, a GUI element of the launcher GUI corresponding to the application.

### CROSS-REFERENCE TO RELATED APPLICATIONS

This application is based upon and claims the benefit of priority from Japanese Patent Application No. 2010-137102, filed Jun. 16, 2010, the entire contents of which are incorporated herein by reference.

### FIELD

Embodiments described herein relate generally to an information terminal, and a computer product and a method thereof.

### BACKGROUND

Information terminals such as common personal computers and mobile phones are usually provided with a graphical user interface (GUI), which allows the users to perform desired operation through the desktop environment set by the GUI. As a type of GUI, there is software or GUI called “launcher”. For example, a pallet launcher arranges the icons of frequently used applications on the display screen so that when the icon of a desired application is clicked, the application can be immediately launched. In general, the launcher can be set to display state and also non-display state.

If the launcher is not displayed, the function of the launcher as GUI cannot be used. Therefore, there is a need for a technology to improve the function of the launcher as GUI when the launcher is not displayed using the relationship between the launcher and applications registered in the launcher.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external view of a tablet personal computer (PC) according to an embodiment;

FIG. 2 is an exemplary block diagram of a hardware configuration of the tablet PC in the embodiment;

FIG. 3 is an exemplary schematic diagram of a software configuration in the embodiment;

FIG. 4 is an exemplary conceptual diagram of an application list in the embodiment;

FIG. 5 is an exemplary flowchart of the operation of a launcher when not displayed in the embodiment;

FIG. 6A is an exemplary schematic diagram of a screen that displays the launcher in the embodiment;

FIG. 6B is an exemplary schematic diagram of the screen that does not display the launcher in the embodiment; and

FIG. 7 is an exemplary schematic diagram of the screen that displays the icon of an application the state of which has changed in the embodiment.

### DETAILED DESCRIPTION

Various embodiments will be described hereinafter with reference to the accompanying drawings. In general, according to one embodiment, an information terminal is provided with a launcher graphical user interface (GUI), and comprises a detector, a determination module, and a display module. The detector is configured to detect a change in the state of an application. The determination module is configured to determine whether the application is set in the launcher GUI. The display module is configured to display, when the launcher GUI is not displayed and the determination module determines that the application is set in the launcher GUI, a GUI element of the launcher GUI corresponding to the application.

According to another embodiment, there is provided a method applied to an information terminal provided with a launcher GUI and a controller. The method comprises: detecting a change in the state of an application by the controller; determining whether the application is set in the launcher GUI by the controller; and displaying, when the launcher GUI is not displayed and the application is set in the launcher GUI, a GUI element of the launcher GUI corresponding to the application by the controller.

According to still another embodiment, a computer program product comprises a computer-readable storage medium having computer readable program codes embodied in the medium that, when executed, causes a computer to implement the above information terminal.

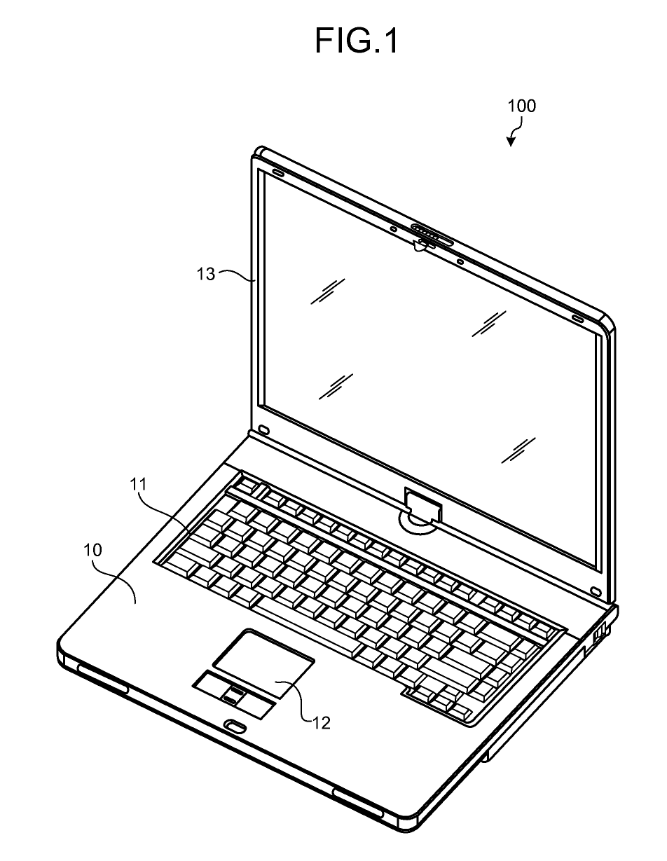

A description will be given of a tablet personal computer (PC) 100 according to an embodiment. FIG. 1 is an external view of the tablet PC 100 according to the embodiment.

The tablet PC 100 is a computer system comprising, as input devices, a keyboard 11, a touchpad 12, and a display device 13. The display device 13 comprises a touch panel on the front surface that detects the coordinate position of a pen or a finger and the contact area thereof.

As illustrated in FIG. 1, the tablet PC 100 has a main body 10 provided with the keyboard 11 and the touchpad 12. Various types of hardware is built in the main body 10 as described below.

The display device 13 further comprises a display panel (display screen) such as a liquid crystal display (LCD) panel. The tablet (touch panel) is provided integrally with the surface of the display panel. In the tablet PC 100, the display device 13 is attached to the main body 10 through a biaxial hinge mechanism to be rotatable between the open position and the closed position. FIG. 1 illustrates the display device 13 in the usual open position (laptop mode). The display device 13 can be rotated 180 degrees from the usual open position into the closed position (tablet mode) in such a manner as to cover the keyboard 11.

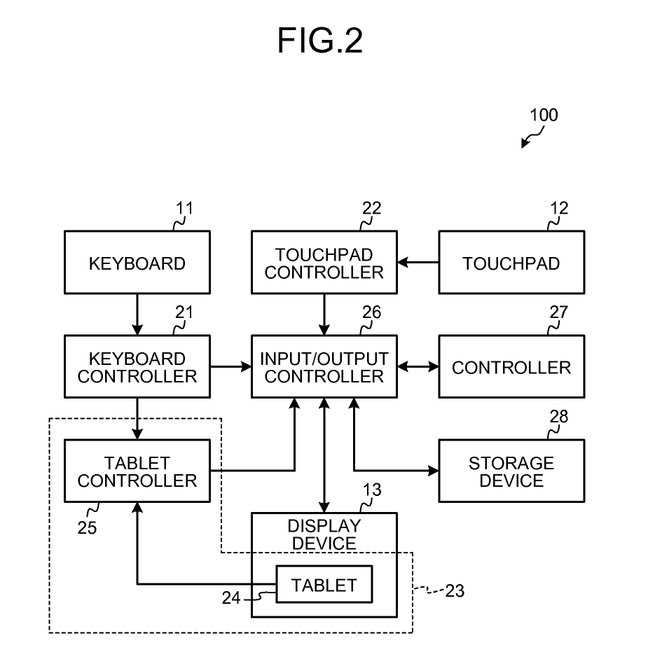

In the following, the hardware configuration of the tablet PC 100 will be described with reference to FIG. 2. FIG. 2 illustrates the hardware configuration of the tablet PC 100.

As illustrated in FIG. 2, the tablet PC 100 comprises a keyboard controller 21 and a touchpad controller 22. The keyboard controller 21 converts key input from the keyboard 11 into input data to be input to the main body 10. The touchpad controller 22 converts operation input from the touchpad 12 into input data to be input to the main body 10.

The tablet PC 100 further comprises a tablet input device 23 as a data input device in addition to the keyboard 11 and the touchpad 12. The tablet input device 23 comprises a tablet (touch panel) 24 and a tablet controller 25 that converts the coordinate position of a pen or a finger and the contact area thereof detected by the tablet 24 into input data.

The tablet PC 100 further comprises an input/output controller 26. The input/output controller 26 transfers data received from the keyboard controller 21, the touchpad controller 22, or the tablet controller 25 to a microprocessor, such as a central processing unit (CPU), of a controller 27. The input/output controller 26 also controls the output operation of the display device 13 and the input/output operation of a storage device 28 such as a hard disk drive (HDD) or a solid-state drive (SSD) under the control of the CPU. The controller 27 comprises memory devices including a system memory, a basic input/output system (BIOS), a random access memory (ROM), and the like. The system memory comprises a random access memory (RAM) into which an operating system (OS) and various types of applications are loaded and which is used as a work area.

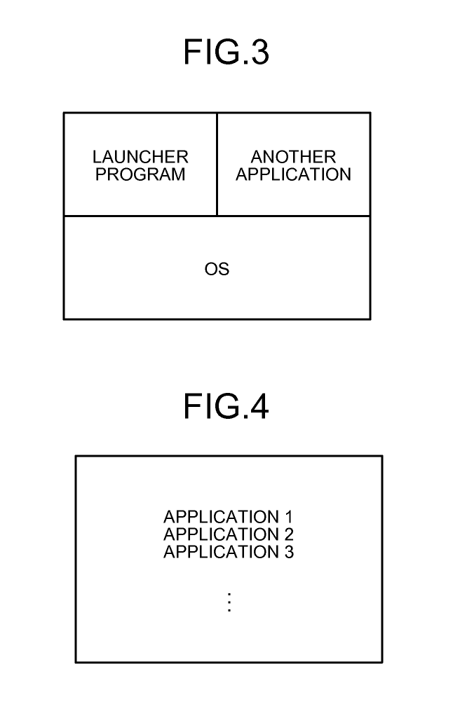

FIG. 3 illustrates the software configuration according to the embodiment. As illustrated in FIG. 3, a launcher program (hereinafter, sometimes simply referred to as “launcher”) is installed on the operating system (OS) as basic software in parallel with other applications (predetermined applications other than the launcher program). It is assumed herein that the launcher program is activated after the tablet PC 100 is activated. Among the other applications, software involving the occurrence of an event (for example, arrival of email) that changes the state thereof before and after the event is running in the background even when it is not open. Examples of such software include a mailer for sending and receiving email, a scheduler for managing a schedule, and the like.

When a predetermined event, such as receipt of email, occurs, a corresponding application (for example, a mailer) notifies the OS of the event (state change notification). In response to the notification, the OS issues (broadcasts) a notification notifying the launcher program and the other applications of the occurrence of the event. From the notification, the launcher detects that the state of the corresponding application has changed (for example, the mailer receives a new email message and the state thereof has changed).

In addition to the above, for the detection of a change in the state of an application, the OS may sends the notification only to the launcher, or the application may broadcast the state change notification to all applications including the OS and the launcher. Alternatively, the launcher may perform the detection based on the content of an event raised by the OS in response to the state change notification sent thereto (for example, the content of display by the OS in response to the state change notification). The launcher may detect a change in the state of an application by any other method.

A description will be given of an application list that the launcher uses to identify an application the state of which has changed. FIG. 4 is a conceptual diagram of the application list.

Generally, a plurality of arbitrary applications are set and registered in a graphical user interface (GUI) displayed by the launcher program (hereinafter, “launcher GUI”). An application may be set in the launcher in various manners. For example, when the user drags an icon as a GUI element corresponding to the application and drops it onto the launcher GUI on the display screen, the application may be set. Alternatively, all applications installed on the tablet PC 100 may be automatically set. In the embodiment, an application set in the launcher GUI is registered in the application list. The application list contains, for example, execution file name of an application, application name of the application to identify the application, or the like.

In the following, a description will be given of characteristic operation of the launcher performed in the tablet PC 100. Incidentally, the launcher operates in the same manner as common launchers when the launcher GUI is displayed.

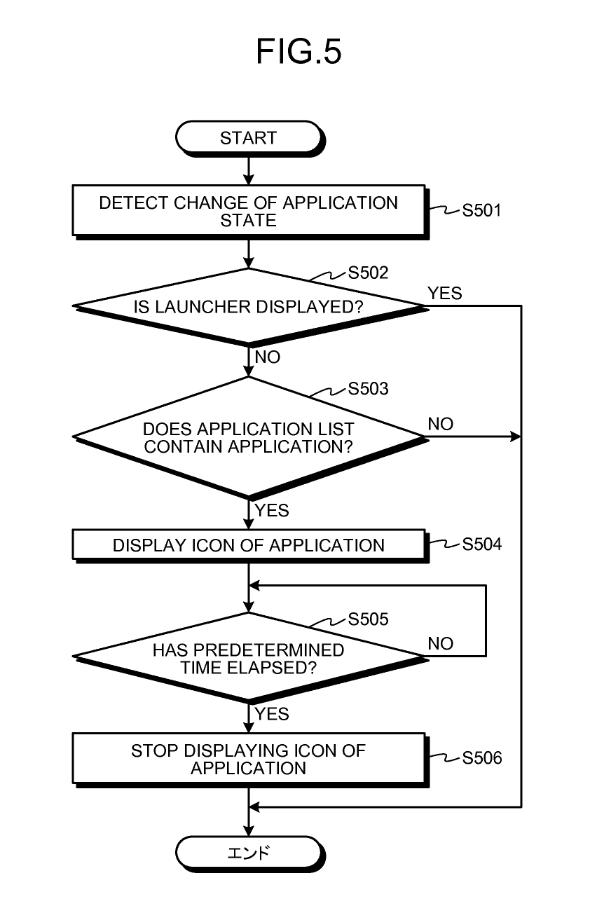

With reference to FIG. 5, a description will be given of the operation of the launcher when not displayed. FIG. 5 is a flowchart of the operation of the launcher when not displayed.

While the following process is performed by the CPU of the controller 27 according to the launcher program, it will be described as being performed by the launcher program for simplicity of the description.

First, the launcher receives a notification from the OS notifying that the state of an application has changed, and thereby detects the change of the application state (S501). Incidentally, it is assumed that the notification contains information to identify the application in the application list (the application name, the execution file name, etc.).

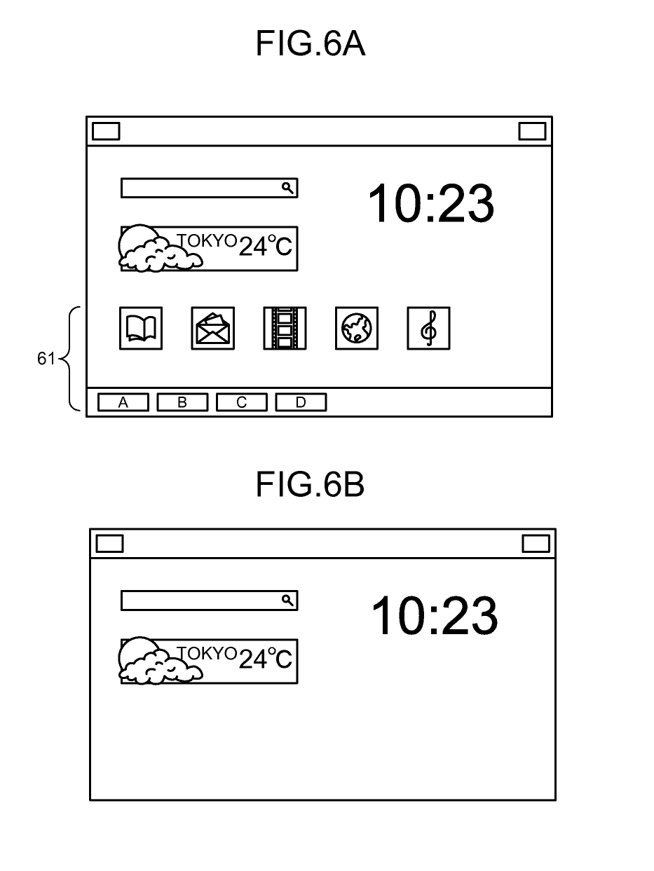

The launcher then determines whether the launcher itself (i.e., the launcher GUI, the same applies to the following) is displayed (S502). FIG. 6A illustrates an example of the screen that displays a launcher GUI 61. FIG. 6B illustrates an example of the screen that does not display the launcher GUI. The display state of the launcher GUI is changed by a predetermined operation of the user. The display state may change when another application is opened. When the display state of the launcher GUI is changed, the launcher can detect whether the launcher itself is displayed by having, for example, a flag as information indicating the display/non-display state.

If the launcher itself is displayed (Yes at S502), the process ends.

On the other hand, having determined that the launcher itself is not displayed (No at S502), the launcher refers to the application list and determines whether the application list contains the application the state change of which is notified at S501, i.e., whether the application is set in the launcher GUI (S503).

If the application is not registered in the application list (No at S503), the process ends.

On the other hand, if the application is registered in the application list (Yes at S503), the icon of the application is displayed (S504). If another application is open at this time, preferably, the icon is displayed forefront.

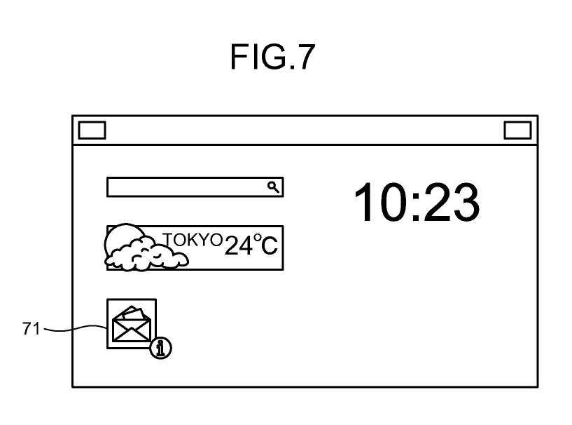

FIG. 7 illustrates an example of the screen that displays the icon of the application the state of which has changed. As illustrated in FIG. 7, only the icon of the application (in the example of FIG. 7, an icon 71 of the mailer) is displayed. The icon is displayed, for example, as being slid up from the bottom of the screen. The display mode of the icon displayed at this time may be different from that of the icon when the launcher GUI is displayed. For example, preferably, the image of the icon may be changed so that the user can easily recognize it (in this case, the launcher has a plurality of GUI elements with respect to the one application for when the launcher GUI is displayed and for when the launcher GUI is not displayed), or an animation effect is applied to the icon being displayed so that it moves (for example, vibrates).

A loop operation is performed until a predetermined time has elapsed (S505). If the predetermined time has not elapsed (No at S505), it is checked again whether the predetermined time has elapsed (S505). If the predetermined time has elapsed (Yes at S505), the process moves to S506.

After the lapse of the predetermined time, the launcher stop displaying the icon displayed at S504 (S506). The predetermined time is preferably five or about five seconds. If the icon is displayed at such time intervals, the user can fully recognize that the state of the application has changed (for example, the mailer receives a new email message, or the like) when the launcher GUI is not displayed (if the user is using the tablet PC 100).

FIG. 5 illustrates an example of the operation of the launcher when not displayed; however, the operation is not so limited. For example, the launcher may determine whether the application list contains the application the state of which has changed before determining whether the launcher itself is displayed.

As described above, according to the embodiment, in response to a change in the state of an application registered in the launcher due to the occurrence of an event such as, for example, receipt of email by the mailer, change of the scheduler at a predetermined time, or the like, the icon of the application is displayed even when the launcher is not displayed. Thus, it is possible to prompt the user to launch the application.

While the tablet PC is described above as an example of the information terminal, the information terminal is not limited thereto. Examples of the information terminal include any type of personal computers, mobile phones, personal digital assistants (PDAs), and the like. The controller 27 that performs S501 of the process flow described above functions as a detector in the tablet PC 100. The controller 27 that performs S503 (and S502) functions as a determination module in the tablet PC 100. The controller 27 that performs S504 according to the determination results previously obtained functions as a display module in the tablet PC 100.

The launcher program of the embodiment may be provided as being stored in advance in ROM or the like. The launcher program may also be provided as being stored in a computer-readable storage medium, such as a compact disc-read only memory (CD-ROM), a flexible disk (FD), a compact disc recordable (CD-R), and a digital versatile disc (DVD), as a file in an installable or executable format. The launcher program may also be stored in a computer connected via a network such as the Internet so that it can be downloaded therefrom via the network.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A terminal provided with a launcher graphical user interface (GUI), comprising:
a detector configured to detect a change in state of an application;
a determination module configured to determine whether the application is set in the launcher GUI; and
a display module configured to display, when the launcher GUI is not displayed and the determination module determines that the application is set in the launcher GUI, a GUI element of the launcher GUI corresponding to the application.

2. The terminal of claim 1, wherein the display module is configured to apply an animation effect to the GUI element upon displaying the GUI element.

3. The terminal of claim 1, wherein the display module is configured to stop displaying the GUI element after a lapse of a predetermined time.

4. The terminal of claim 3, wherein the predetermined time is about five seconds.

5. A computer program product comprising a computer-readable storage medium having computer readable program codes embodied in the medium that, when executed, cause a computer to implement a launcher graphical user interface (GUI) to perform:
detecting a change in state of an application;
determining whether the application is set in the launcher GUI; and
displaying, when the launcher GUI is not displayed and the application is set in the launcher GUI, a GUI element of the launcher GUI corresponding to the application.

6. The computer program product of claim 5, wherein an animation effect is applied to the GUI element when the GUI element is displayed.

7. The computer program product of claim 5, wherein the program codes embodied in the medium, when executed, further cause the computer to implement the launcher GUI to perform stopping displaying the GUI element after a lapse of a predetermined time.

8. The computer program product of claim 7, wherein the predetermined time is about five seconds.

9. A method applied to an information terminal provided with a launcher graphical user interface (GUI) and a controller, the method comprising:
with the controller, detecting a change in state of an application;
with the controller, determining whether the application is set in the launcher GUI; and
with the controller, displaying, when the launcher GUI is not displayed and the application is set in the launcher GUI, a GUI element of the launcher GUI corresponding to the application.

10. The method of claim 9, wherein an animation effect is applied to the GUI element when the GUI element is displayed.

11. The method of claim 9, wherein displaying includes stopping displaying the GUI element after a lapse of a predetermined time.

12. The method of claim 11, wherein the predetermined time is about five seconds.
